(19) United States
(12) Patent Application Publication
(10) Pub. No.: US 2023/0223975 A1
(43) Pub. Date: Jul. 13, 2023

(54) Smart Phone Protection Case Assembly

(71) Applicant: Carlos Higuera, Bellflower, CA (US)

(72) Inventor: Carlos Higuera, Bellflower, CA (US)

(21) Appl. No.: 17/574,888

(22) Filed: Jan. 13, 2022

(51) Int. Cl. H04B 1/3888; H04M 1/02; H04M 1/21

(52) U.S. Cl. CPC H04B 1/3888; H04M 1/0279; H04M 1/21

(57) ABSTRACT

A smart phone protection case assembly for facilitating a user to view a smart phone while lying down includes a smart phone case for containing a smart phone such that a display of the smart phone is visible. A lid is hingedly coupled to the smart phone case and the lid is positionable in a closed position or an open position. A mirror is positioned in the lid such that the mirror reflects the display on the smart phone when the lid is in the open position. In this way the mirror facilitates a user to view the display in the mirror. A pocket is integrated into the lid to insertably receive a credit/debit card.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to case devices and more particularly pertains to a new case device for facilitating a user to view a smart phone while lying down. The device includes a smart phone case for receiving a smart phone, a lid hingedly coupled to the smart phone case and a mirror disposed on the lid. The mirror reflects a display of the smart phone when the lid is opened. In this way the user can view the display in the mirror while the user is lying down with the smart phone case lying on their body.

### (2) Description of Related Art Including Information Disclosed Under 37 CFR 1.97 and 1.98

The prior art relates to case devices including a variety of smart phone stands for propping a smart phone up in an upright position to facilitate the smart phone to be viewed. The prior art discloses a variety of smart phone cases for protecting a smart phone from impact damage. The prior art discloses a smart phone case with a foldable element for containing a foldable smart device. The prior art discloses a cosmetics case which can be attached to a smart phone case and which includes a mirror.

### (h) BRIEF SUMMARY OF THE INVENTION

An embodiment of the disclosure meets the needs presented above by generally comprising a smart phone case for containing a smart phone such that a display of the smart phone is visible. A lid is hingedly coupled to the smart phone case and the lid is positionable in a closed position or an open position. A mirror is positioned in the lid such that the mirror reflects the display on the smart phone when the lid is in the open position. In this way the mirror facilitates a user to view the display in the mirror. A pocket is integrated into the lid to insertably receive a credit/debit card.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a smart phone protection case assembly according to an embodiment of the disclosure.

FIG. 2 is a back perspective view of an embodiment of the disclosure.

FIG. 3 is a front view of an embodiment of the disclosure.

FIG. 4 is a back view of an embodiment of the disclosure.

FIG. 5 is a right side view of an embodiment of the disclosure.

FIG. 6 is a perspective in-use view of an embodiment of the disclosure.

### (j) DETAILED DESCRIPTION OF THE INVENTION

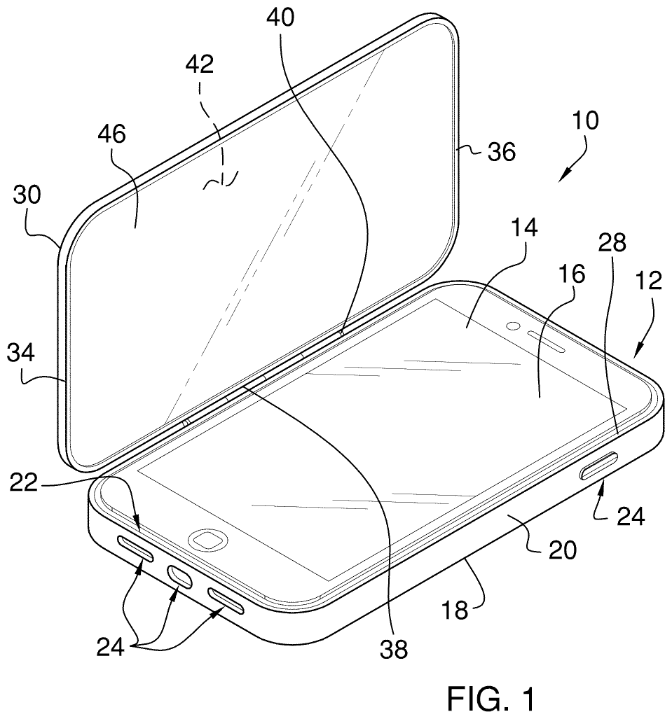

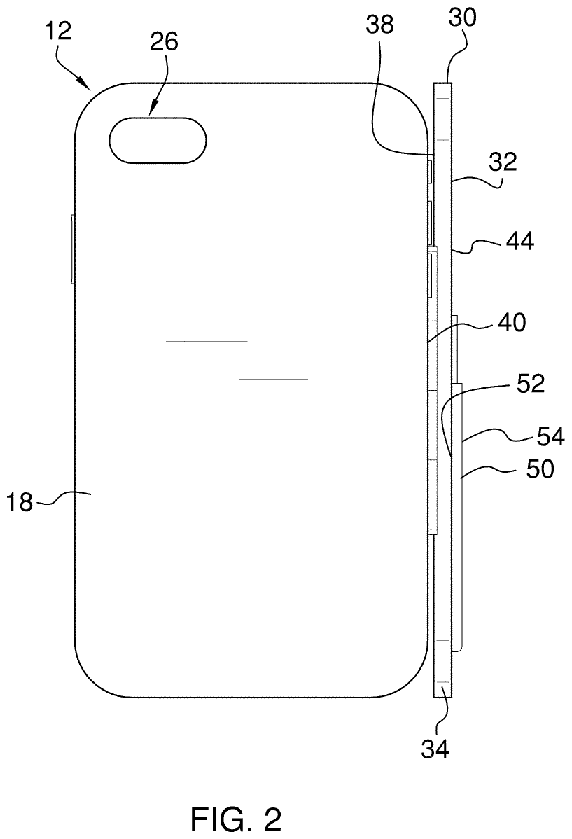

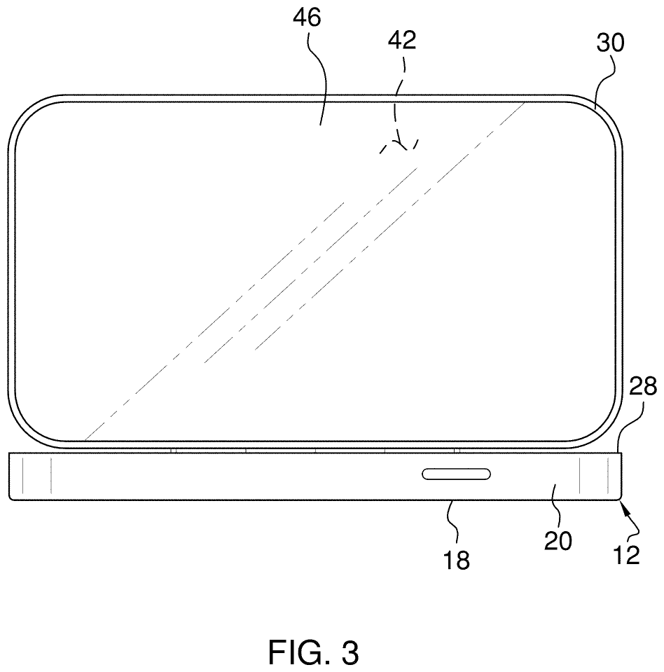

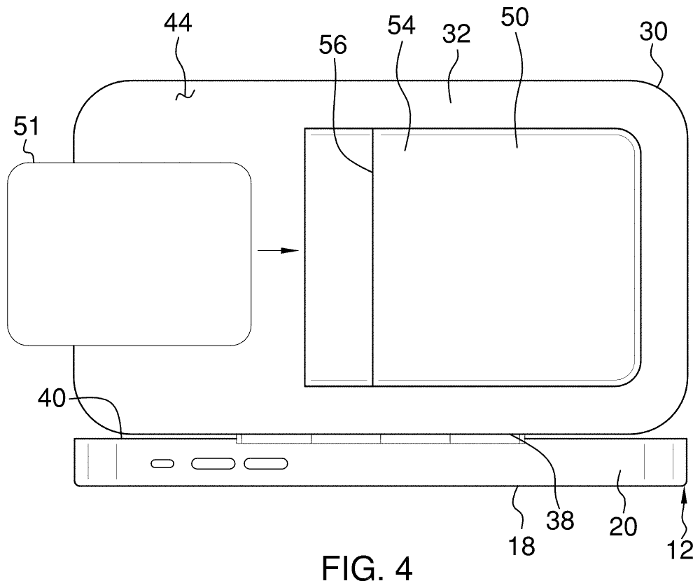

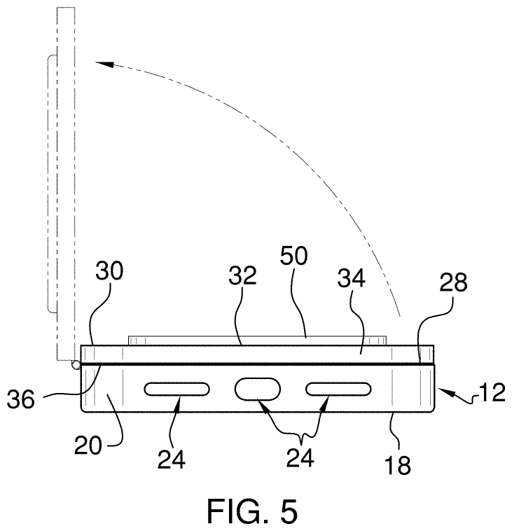

With reference now to the drawings, and in particular to FIGS. 1 through 6 thereof, a new case device embodying the principles and concepts of an embodiment of the disclosure and generally designated by the reference numeral 10 will be described.

As best illustrated in FIGS. 1 through 6, the smart phone protection case assembly 10 generally comprises a smart phone case 12 for containing a smart phone 14 such that a display 16 of the smart phone 14 is visible. The smart phone case 12 has a basal wall 18 and a perimeter wall 20 extending away from the basal wall 18 such that the perimeter wall 20 defines a smart phone space 22 for receiving the smart phone 14. The perimeter wall 20 has a plurality of access holes 24 each extending through the perimeter wall 20. Additionally, each of the access holes 24 is strategically located to facilitate controls on the smart phone 14 to be accessible through the access holes 24. The basal wall 18 has a camera opening 26 extending through the basal wall 18 and the camera opening 26 is strategically located to facilitate a camera on the smart phone 14 to be aligned with the camera opening 26. The perimeter wall 20 has a distal edge 28 with respect to the basal wall 18, and the smart phone case 12 is comprised of an impact resistant material for protecting the smart phone 14.

A lid 30 is hingedly coupled to the smart phone case 12 and the lid 30 is positionable in a closed position or an open position. The lid 30 has a top wall 32 and a peripheral wall 34 extending away from the top wall 32, and the peripheral wall 34 has a distal edge 36 with respect to the top wall 32. The distal edge 36 corresponding to a first side 38 of the peripheral wall 34 is hingedly coupled to the distal edge 28 corresponding to a first side 40 of the perimeter wall 20 of the smart phone case 12. Furthermore, the distal edge 36 of the peripheral wall 34 rests against the distal edge 28 of the perimeter wall 20 when the lid 30 is in the closed position. The top wall 32 has a first surface 42 and a second surface 44, and the peripheral wall 34 extends away from the first surface 42.

A mirror 46 is provided and the mirror 46 is positioned in the lid 30. The mirror 46 is comprised of a light reflecting material such that the mirror 46 reflects the display 16 on the smart phone 14 when the lid 30 is in the open position. In this way the mirror 46 facilitates a user 48 to view the display 16 in the mirror 46 while the user 48 is lying down, sitting at a table or a flat surface. The mirror 46 is bonded to the first surface of the top wall 32 of the lid 30 and the mirror 46 completely covers the first surface 42 of the top wall 32. A pocket 50 is integrated into the lid 30 to insertably receive a credit/debit card 51. The pocket 50 has a rear side 52 and a front side 54, and the rear side 52 is bonded to the second surface 44 of the top wall 32 of the lid 30. The front side 54 has a slot 56 extending into an interior of the pocket 50 to insertably receive the credit/debit card 51.

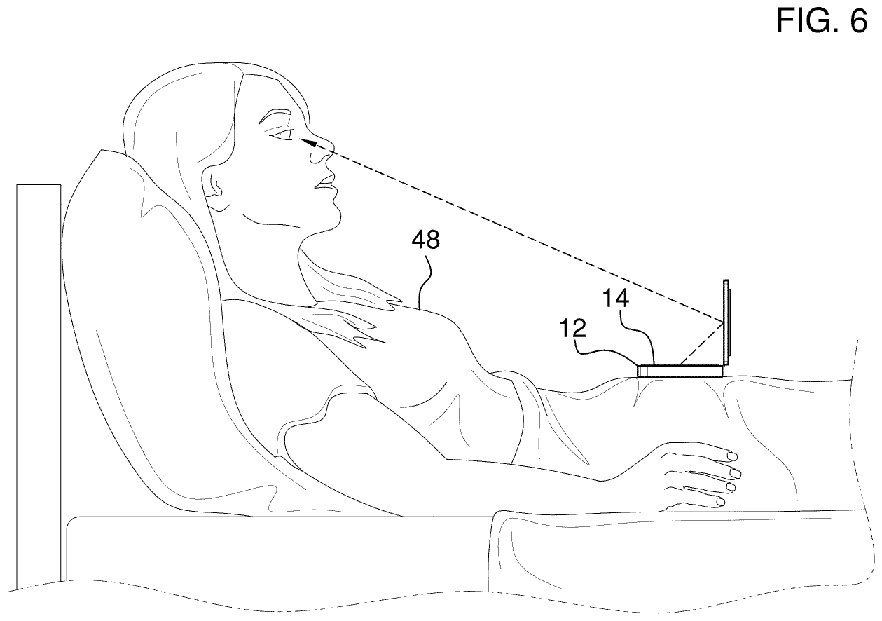

In use, the smart phone 14 is positioned in the smart phone case 12 such that the display 16 is visible in the smart phone case 12. The lid 30 is positioned in the open position at an angle that facilitates the mirror 46 to reflect the display 16. In this way, as is most clearly shown in FIG. 6, the user 48 can view the display 16 in the mirror 46 while the user 48 is lying down with the smart phone case 12 lying on their body. Furthermore, the mirror 46 facilitates the display 16 to be visible when the user 48 is seated at a table or sitting on any flat surface. Thus, the user 48 does not have to hold the smart phone 14 to view the display 16 while the user 48 is lying down or while the user 48 is seated at a table or on a flat surface. The lid 30 is positioned in the closed position for transporting the smart phone case 12. Additionally, the credit/debit card 51 can be stored in the pocket 50 on the lid 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A smart phone protection case assembly for facilitating hands free viewing of a smart phone, said assembly comprising:
a smart phone case for containing a smart phone such that a display of the smart phone is visible;
a lid being hingedly coupled to said smart phone case, said lid being positionable in a closed position or an open position;
a mirror being positioned in said lid, said mirror being comprised of a light reflecting material such that said mirror reflects the display on said smart phone when said lid is in said open position wherein said mirror is configured to facilitate a user to view the display in said mirror; and
a pocket being integrated into said lid wherein said pocket is configured to insertably receive a credit/debit card.

2. The assembly according to claim 1, wherein said smart phone case has a basal wall and a perimeter wall extending away from said basal wall such that said perimeter wall defines a smart phone space for receiving the smart phone, said perimeter wall having a plurality of access holes each extending through said perimeter wall, each of said access holes being strategically located to facilitate controls on the smart phone to be accessible through said access holes, said basal wall having a camera opening extending through said basal wall, said camera opening being strategically located to facilitate a camera on the smart phone to be aligned with said camera opening, said perimeter wall having a distal edge with respect to said basal wall.

3. The assembly according to claim 2, wherein said lid has a top wall and a peripheral wall extending away from said top wall, said peripheral wall having a distal edge with respect to said top wall, said distal edge corresponding to a first side of said peripheral wall being hingedly coupled to said distal edge corresponding to a first side of said perimeter wall of said smart phone case, said distal edge of said peripheral wall resting against said distal edge of said perimeter wall when said lid is in said closed position, said top wall having a first surface and a second surface, said peripheral wall extending away from said first surface.

4. The assembly according to claim 3, wherein said mirror is bonded to said first surface of said top wall of said lid, said mirror completely covering said first surface of said top wall.

5. The assembly according to claim 3, wherein said pocket has a rear side and a front side, said rear side being bonded to said second surface of said top wall of said lid, said front side having a slot extending into an interior of said pocket wherein said slot is configured to insertably receive the credit/debit card.

6. A smart phone protection case assembly for facilitating hands free viewing of a smart phone, said assembly comprising:
a smart phone case for containing a smart phone such that a display of the smart phone is visible, said smart phone case having a basal wall and a perimeter wall extending away from said basal wall such that said perimeter wall defines a smart phone space for receiving the smart phone, said perimeter wall having a plurality of access holes each extending through said perimeter wall, each of said access holes being strategically located to facilitate controls on the smart phone to be accessible through said access holes, said basal wall having a camera opening extending through said basal wall, said camera opening being strategically located to facilitate a camera on the smart phone to be aligned with said camera opening, said perimeter wall having a distal edge with respect to said basal wall;
a lid being hingedly coupled to said smart phone case, said lid being positionable in a closed position or an open position, said lid having a top wall and a peripheral wall extending away from said top wall, said peripheral wall having a distal edge with respect to said top wall, said distal edge corresponding to a first side of said peripheral wall being hingedly coupled to said distal edge corresponding to a first side of said perimeter wall of said smart phone case, said distal edge of said peripheral wall resting against said distal edge of said perimeter wall when said lid is in said closed position, said top wall having a first surface and a second surface, said peripheral wall extending away from said first surface;
a mirror being positioned in said lid, said mirror being comprised of a light reflecting material such that said mirror reflects the display on the smart phone when said lid is in said open position wherein said mirror is configured to facilitate a user to view the display in said mirror, said mirror being bonded to said first surface of said top wall of said lid, said mirror completely covering said first surface of said top wall; and
a pocket being integrated into said lid wherein said pocket is configured to insertably receive a credit/debit card, said pocket having a rear side and a front side, said rear side being bonded to said second surface of said top wall of said lid, said front side having a slot extending into an interior of said pocket wherein said slot is configured to insertably receive the credit/debit card.

7. A smart phone case system for facilitating hands free viewing of a smart phone, said system comprising:
a smart phone having a display, controls and a camera;
a smart phone case for containing said smart phone such that said display of said smart phone is visible, said smart phone case having a basal wall and a perimeter wall extending away from said basal wall such that said perimeter wall defines a smart phone space for receiving said smart phone, said perimeter wall having a plurality of access holes each extending through said perimeter wall, each of said access holes being strategically located to facilitate said controls on said smart phone to be accessible through said access holes, said basal wall having a camera opening extending through said basal wall, said camera opening being strategically located to facilitate said camera on said smart phone to be aligned with said camera opening, said perimeter wall having a distal edge with respect to said basal wall;
a lid being hingedly coupled to said smart phone case, said lid being positionable in a closed position or an open position, said lid having a top wall and a peripheral wall extending away from said top wall, said peripheral wall having a distal edge with respect to said top wall, said distal edge corresponding to a first side of said peripheral wall being hingedly coupled to said distal edge corresponding to a first side of said perimeter wall of said smart phone case, said distal edge of said peripheral wall resting against said distal edge of said perimeter wall when said lid is in said closed position, said top wall having a first surface and a second surface, said peripheral wall extending away from said first surface;
a mirror being positioned in said lid, said mirror being comprised of a light reflecting material such that said mirror reflects said display on said smart phone when said lid is in said open position wherein said mirror is configured to facilitate a user to view said display in said mirror, said mirror being bonded to said first surface of said top wall of said lid, said mirror completely covering said first surface of said top wall; and
a pocket being integrated into said lid wherein said pocket is configured to insertably receive a credit/debit card, said pocket having a rear side and a front side, said rear side being bonded to said second surface of said top wall of said lid, said front side having a slot extending into an interior of said pocket wherein said slot is configured to insertably receive the credit/debit card.
